(19) United States
(12) Patent Application Publication
(10) Pub. No.: US 2003/0018771 A1
(43) Pub. Date: Jan. 23, 2003

(54) Method and apparatus for generating and recognizing speech as a user interface element in systems and network management

(75) Inventor: Anders Vinberg, Plandome Manor, NY (US)

Correspondence Address: Calfee, Halter & Griswold LLP, 1650 Fifth Third Center, 21 East State Street, Columbus, OH, 43215-4243, US

(73) Assignee: COMPUTER ASSOCIATES THINK, INC.

(21) Appl. No.: 10/091,067

(22) Filed: Mar. 4, 2002

Related U.S. Application Data
(63) Continuation-in-part of application No. 09/949,101, filed on Sep. 7, 2001.
Application No. 09/949,101 is a continuation of application No. 09/408,213, filed on Sep. 27, 1999, now Pat. No. 6,289,380.
Application No. 09/408,213 is a continuation of application No. 08/892,919, filed on Jul. 15, 1997, now Pat. No. 5,958,012.
(60) Provisional application No. 60/272,972, filed on Mar. 2, 2001.

(51) Int. Cl. G06F 15/173; G09G 5/00

(52) U.S. Cl. 709/223; 345/736; 345/737

(57) ABSTRACT

A method for generating audio alerts is disclosed. The method includes detecting an alert condition, and determining a notification path associated with the alert condition. The method also includes constructing an audio notification message based on at least one parameter associated with the alert condition, and outputting the audio notification message via the notification path. A method for processing audio commands is also disclosed. This method includes receiving an audio command from a user and processing the audio command to derive command data. The method further includes constructing a command based on the command data, and storing the command in an object repository. Systems and computer-readable storage media for generating an audio alert and processing an audio command are also disclosed.

### RELATED APPLICATIONS

This application is a Continuation-In-Part of U.S. Ser. No. 09/949,101 filed Sep. 7, 2001, which is a Continuation of U.S. Pat. No. 6,289,380 issued Sep. 11, 2001, which is a Continuation of U.S. Pat. No. 5,958,012 issued Sep. 28, 1999. This application claims priority to U.S. Provisional Application Serial No. 60/272,972 filed Mar. 2, 2001. The present application incorporates each related application by reference in its entirety.

### TECHNICAL FIELD

The present application generally relates to the field of monitoring and managing ongoing processes. Within this field, the present application addresses generating alert and diagnostic messages for the attention of human operators.

### BACKGROUND

Systems that manage computer or network systems, or other systems with embedded computer technology, commonly monitor various system parameters for the purpose of detecting problems and alerting human operators to the problem. Various techniques can be employed to monitor ongoing processes. The monitored values can be analyzed in various ways, including comparison with thresholds, correlation of several values, and correlation of values over time to discover problems, unprecedented situations, or other events.

Some systems use various techniques to predict events before they occur. One such system is described in commonly owned U.S. Pat. No. 6,327,550, which is incorporated herein in its entirety by reference. In such systems one response to the discovery or prediction is to bring the event to the attention of a human operator. For example, these management systems can issue a text message alert and different techniques may be employed for presenting this text message to the operator, such as a Windows dialog box, monitoring consoles, event logs, email messages, pager messages. The alert can also be a provided as an audio message through loudspeakers, headsets, or a telephone. An example of a system that provides audio alert messaging is described in commonly owned, concurrently filed, co-pending U.S. Utility Application entitled “Method and Apparatus for Generating and Recognizing Speech as a User Interface Element in Systems and Network Management,” which is incorporated herein in its entirety by reference.

In large management systems with many managed components and/or networks and a high level of activity, the management systems may generate a large number of alert messages. Some alert messages may be more important than others, but are typically issued because the alert functionality of such management systems is not open to modification. Other messages may be redundant because several management systems may independently detect the consequences of an event. As a result, current management systems include various techniques for filtering such alert messages based on various rules unrelated to the content of the message. For example, some conventional management systems designate the severity of a detected or predicted event as the filtering rule. This permits the management system to present only critical messages, or messages about events above a certain level of severity. Other systems correlate alert messages over time or over several objects as a filtering rule. This permits the recognition that a message may indicate a critical problem, even though it may not indicate such criticality by itself, e.g., a minor error may be more critical if it occurs several times in a short time period.

Even after messages have been filtered so only meaningful messages remain, individual users may be interested in different categories of messages. Some management systems include various techniques for filtering alert messages presented to particular individuals, such as messages related to one or more groups of managed components or networks that denote some sort of business process. An example of such a management system is described in commonly owned U.S. Pat. No. 5,958,012, which is incorporated herein in its entirety by reference.

### SUMMARY

This disclosure provides methods and systems for generating audio alert messages and processing audio commands in enterprise management systems. According to one aspect of the disclosure, a method for generating an audio alert is disclosed. The method includes detecting an alert condition, determining a notification path associated with the alert condition, constructing an audio notification message based on at least one parameter associated with the alert condition, and outputting the audio notification message via the notification path. The method enables one or more human operators to be notified by an enterprise management system of events affecting the operation of enterprise components and/or the infrastructure or networks that interconnect the components.

According to a second aspect of the disclosure, a method for processing audio commands is disclosed. In this embodiment, the method includes receiving an audio command from a user, processing the audio command to derive command data, constructing a command based on the command data and storing the command in an object repository. This methodology enables a human operator to remotely control enterprise management systems using voice commands.

The present disclosure also provides systems for generating and presenting audio alerts. In one embodiment, the system includes means for detecting an alert condition, means for determining a notification path associated with the alert condition, means for constructing an audio notification message based on at least one parameter associated with the alert condition, and means for outputting the audio notification message via the notification path.

According to another aspect of the disclosure, a system for processing audio commands is disclosed. The system includes means for receiving an audio command from a user, means for processing the audio command to derive command data, means for constructing a command based on the command data and means for storing the command in an object repository.

Computer-readable storage media are also disclosed which includes processing instructions for implementing certain disclosed methods.

### BRIEF DESCRIPTION OF THE DRAWINGS

For a more complete understanding of the present methods and systems, reference is now made to the following description taken in conjunction with the accompanying drawings in which like reference numbers indicate like features and wherein:

FIG. 1A illustrates an exemplary enterprise system;

FIG. 1B illustrates an exemplary management system topology that may be used to manage an IT enterprise in accordance with the disclosed methodology;

FIG. 2 illustrates a more detailed view of the exemplary management system of FIG. 1B connected to components of an IT enterprise;

FIG. 3 is an exemplary methodology for generating audio alerts according to one embodiment of the present disclosure; and

FIG. 4 is an exemplary methodology for processing audio commands according to one embodiment of the present disclosure.

### DETAILED DESCRIPTION

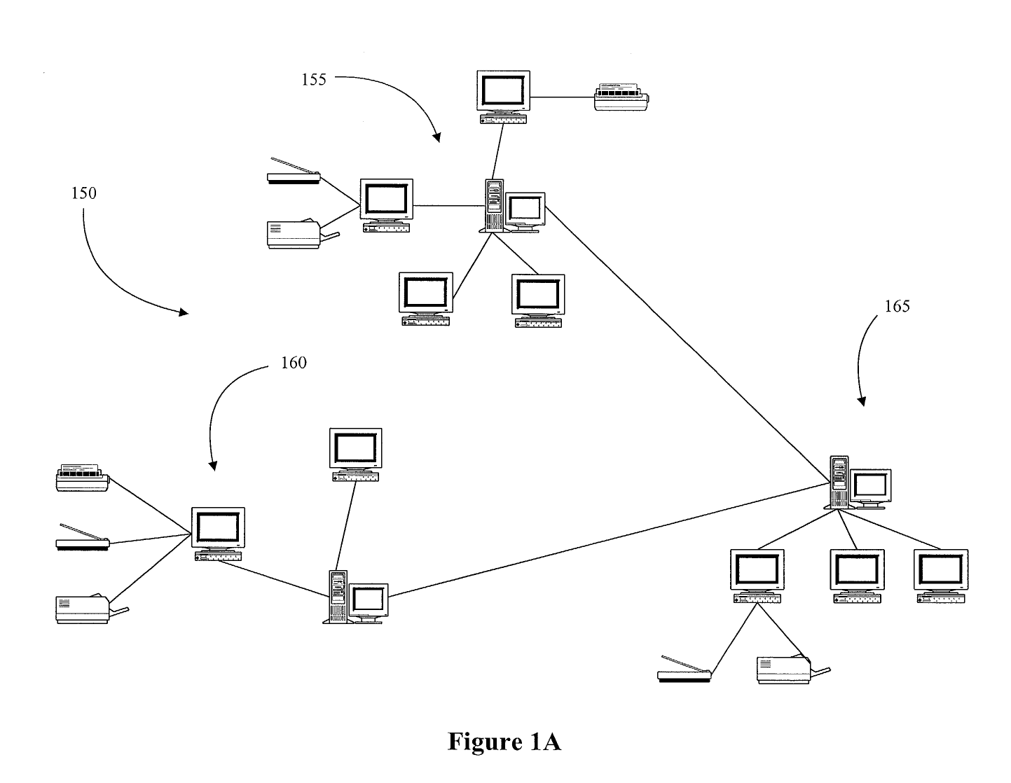

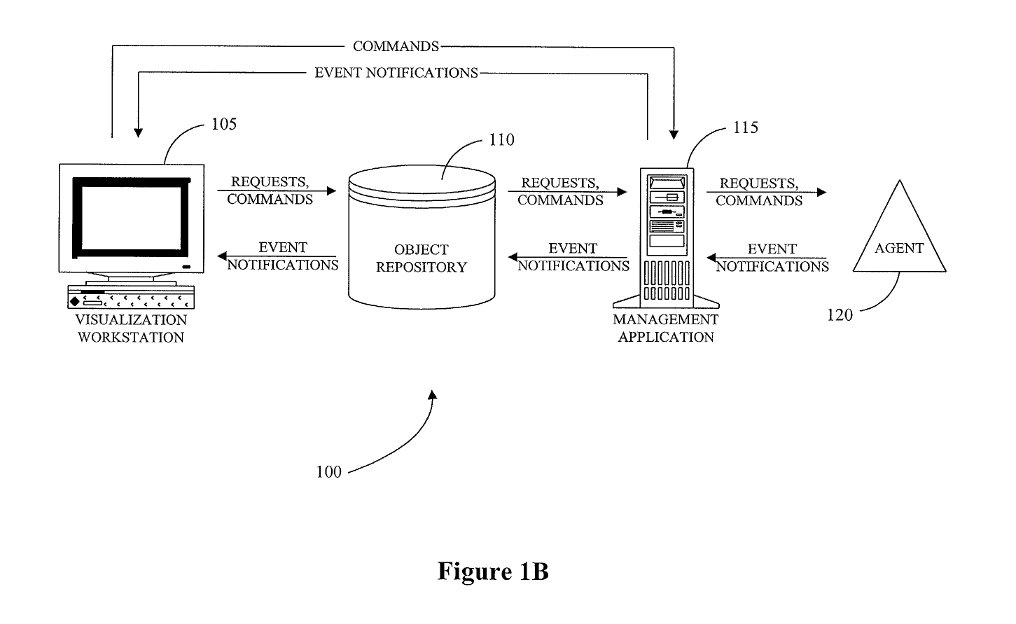

An exemplary IT enterprise is illustrated in FIG. 1A. The IT enterprise 150 includes local area networks 155, 160 and 165. IT enterprise further includes a variety of hardware and software components, such as workstations, printers, scanners, routers, operating systems, applications, and application platforms, for example. The components of IT enterprise 150 may be monitored and managed in accordance with the present disclosure.

The various components of an exemplary management system 100 topology that can manage an IT enterprise in accordance with the present disclosure are shown in FIG. 1B. The management system 100 includes at least one visualization workstation 105, an object repository 110, one or more management applications 115, and one or more management agents 120 associated with each management application 115.

The visualization workstation 105 provides a user access to various applications including a network management application 115. Workstation 105 interacts with an object repository 110 which stores and delivers requests, commands and event notifications. Workstation 105 requests information from object repository 110, sends commands to the object repository, and gets notification of events, such as status changes or object additions from it. The object repository 110 receives request information from the management application 115, which is fed by the management agents 120 responsible for monitoring and managing certain components or systems in an IT enterprise.

The management application 115 maintains object repository 110 to keep track of the objects under consideration. The object repository 110 may be a persistent store to hold information about managed components or systems, such as a database. In an alternative embodiment, the management application 115 and object repository 110 may be integrated into a single unit that can hold information about managed components in volatile memory and perform the tasks of the management application.

As shown, one architectural aspect of the present system is that in normal operation, the visualization workstation 105 interacts primarily with the object repository 110. This reduces network traffic, improves the performance of graphical rendering at the workstation, and reduces the need for interconnectivity between the visualization workstation 105 and a multitude of management applications 115, their subsystems and agents 120 existing in IT enterprises. Of course, embodiments having other configurations of the illustrated components are contemplated, including a stand-alone embodiment in which the components comprise an integrated workstation.

In addition to handling requests, commands and notifications, object repository 110 may also handle objects describing the structure and operation of the management system 100. Such objects may describe the momentary state, load, and performance of the components and/or systems. Such objects may be populated using a manual process or an automatic discovery utility.

According to one embodiment, the management system of the present disclosure includes an alert system that is capable of providing audio alerts to operators. Another embodiment of the management system of the present disclosure includes the alert system and a command/control system that is capable responding to verbal commands from devices that supports speech generation or reproduction.

The alert system includes an alert generation component that communicates with a speech generation component to provide speech-based audio alerts. The command/control system includes a speech recognition component that communicates with a command/control component (or user interface) to enable human operators to verbally request retrieval of information from the management system, or to verbally issue commands to the management system to take certain actions. This combined speech-based alert system and command/control system may be incorporated as part of the management application 115 of the management system 100 or as a user interface in any kind of component (e.g., computer) connected to the IT enterprise. In one embodiment, this is accomplished using speakers and a microphone, or in alternative configurations, using a headset with headphones and an integrated microphone. In alternative embodiments, the combined alert system and command/control system (collectively referred to herein as the ACC system) is connected to a telephony system, to allow alert messages to be sent out to an operator through a telephone and commands to be received through a telephone. In still other alternative embodiments, the speech-based system may be connected to a handheld device, such as a Palm Pilot. Of course, any handheld device used with the present system should be capable of supporting audio and/or speech generation. Thus, the present system is readily capable of exploiting any new devices supporting speech generation as they become available.

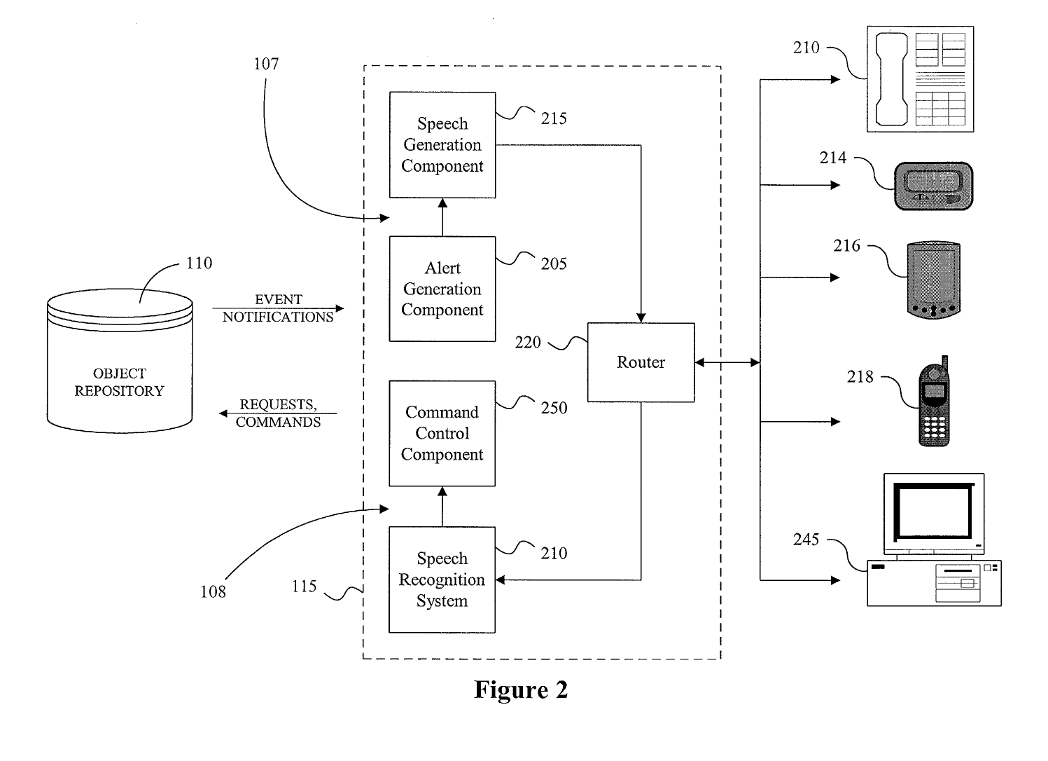

Referring now to FIG. 2, one embodiment of an ACC system according to the present disclosure is shown. The alert system 107 includes alert generation component 205 and speech generation component 215 that interacts with devices 210-245, as described below, via router 220. The command/control system 108 includes command/control component 250 and speech recognition component 210 that interacts with devices 210-245, as described below, via router 220. Information can be stored in or retrieved from object repository 110 by alert generation component 205 or command control component 250. In this embodiment, at least a potion of the ACC system is integrated with the management application 115 and another portion of the ACC system is integrated with the object repository 110. In an alternative embodiment, the ACC system can be integrated with the management application 115, and in another alternative embodiment the ACC system can be integrated with the object repository 110 and another component in the IT enterprise.

In addition, in the embodiment of FIG. 2, the alert system 107, the command/control system 108 or both interact with the devices 210-245 via a single communication path, e.g., router 220. This configuration provides a unified alerting system and a unified command-and-control system for various enterprise components, networks or subsystems in the IT enterprise. Further, like management application 115, other enterprise components, networks and/or subsystems may populate the object repository 110 with event notifications that may be delivered according to the methodology of the present application.

In conventional management systems subsystems are typically responsible for generating and delivering their own event notifications, and handling commands from operators (or users). For example, virus detection, intrusion detection, system performance monitoring, network monitoring, application monitoring, job scheduling, and access control are traditionally handled by separate subsystems with separate user interfaces and separate alerting systems. By providing an integrated user interface for reporting events and receiving commands in accordance with the present disclosure, management systems can more efficiently manage an enterprise, particularly with regard to the use of audio notifications and commands.

In addition to communicating event notifications to visualization workstation 105, object repository 110 further provides such notifications to the alert generation component 205. Alert generation component 205 processes each notification to determine whether an audio alert notification should be transmitted, and if so, determines how the alert is to be transmitted. If the alert generation component 205 is configured to provide an audio alert notification for a particular event, alert generation component 205 employs speech generation component 215 to generate the audio alert notification. The audio alert notification is then transmitted via router 220 to any of a number of devices that support speech generation or reproduction. Such devices, for example, include without limitation telephone 225, pager 230, PDA 235, mobile telephone 240 and visualization workstation or computer 245.

Further, in addition to receiving requests and commands from visualization workstation 105, object repository 110 may receive requests and/or commands via command control component 250. Upon receiving an audio command from a device that supports speech generation or reproduction via router 220, speech recognition system 210 converts the audio command into command data that may operate as input to the command control component 250. The conversion of the audio command into command data may be accomplished using conventional speech processing techniques, know to one of ordinary skill in the art. As noted, speech recognition system 210 receives requests and/or commands in a verbal form from other devices, for example devices 225-245. Such commands may be in response to an alert generated by alert generation component 205.

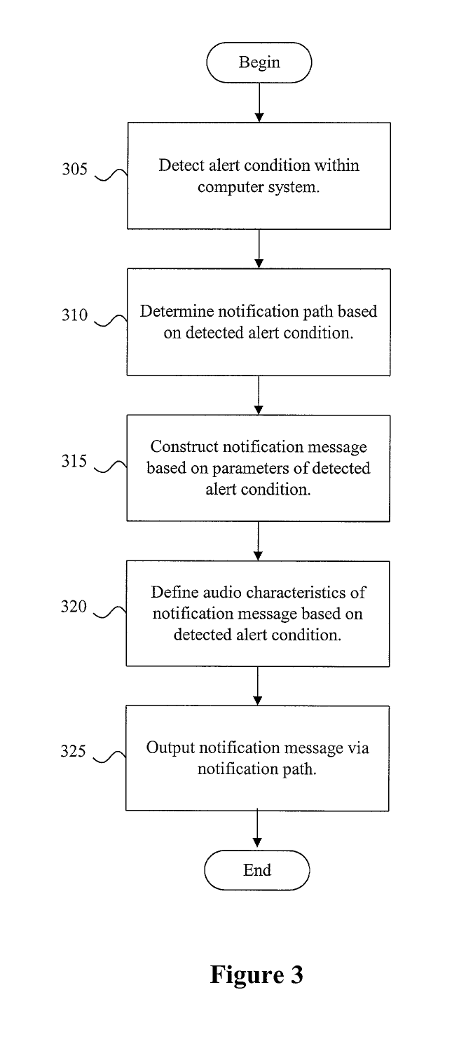

Referring now to FIG. 3, there is illustrated a flowchart describing the operation of one methodology for generating audio alerts. At block 305, an alert condition is detected within the IT enterprise. The alert condition may be detected by alert generation component 205 based on an event notification received from object repository 110. At block 310, alert generation component 205 determines a notification path associated with the detected alert condition. The notification path may direct that an alert be sent to one or more devices 210-245, and may be determined based on previous events, such as whether a prior alert has been generated without a response.

According to one embodiment of the present application, the determination of the notification path may be accomplished using a system for directing messages to different users depending on severity, type of object or any other parameter that may be the basis for filtering event notifications. Such a mechanism may be useful since many different types of messages, from many different contexts may be generated in a typical management system. A system for filtering messages is described in concurrently filed application entitled “Method and Apparatus for Filtering Messages Based on Context,” which is incorporated herein in its entirety by reference. Further, the determination of the notification path may include determining multiple paths to enable more than one user to be designated to receive a particular type of audio alert notification.

In addition to supporting the transmission of audio alert notifications to multiple users, the alert system 107 may also be configured to utilize an escalation list. An escalation list is a list of people to be notified for a particular class of message. The list may be stored in object repository 110, the management application 115, the alert generation component 205 or other storage facility. The list may be multi-tiered and may represent several levels of responsibility. For example, the list may include a first set of one or more operators who are primarily responsible for a particular alert, and a second set of one or more operators who are responsible if no one from the first set addresses the event within a particular period of time. Of course, the escalation list may be structured in a variety of ways, with any number of levels.

Given an escalation list with two operators, the list can be constructed, for example, such that if a first person on the escalation list does not respond to a phone message within five minutes, the second person on the list may be notified. In such an example, the alert system may deliver the following exemplary audio alert notification to a telephone associated with the second person:

“The NT server uschdb02 is predicted to begin thrashing within half an hour. We attempted to notify Sally Robinson, but she did not respond. You are responsible for handling this alert.”

Some persons may be designated to be notified even if others have been given responsibility for handling a problem. For example, the alert system may deliver the following exemplary message to a manager:

“The NT server uschdb02 is predicted to begin thrashing within half an hour. This message is for information only. We have notified Bob Jones, who is the operator on duty and is responsible for handling this problem.”

According to alternative embodiments of the present application, the management application 115 may include a facility for escalating the message to the next responsible manager if a problem is not addressed within a designated time limit, or if the same problem occurs several times within a designated time period. For example, the system may deliver the following message to the next responsible manager:

“The NT server uschdb02 has gone into thrashing three times within the past hour. We have notified Bob Jones, who is the operator on duty and is responsible for handling this problem.”

The management system 100 may also be configured employ control logic for intelligently filtering and selectively providing audio alert notifications. Such filtering control logic may be useful to avoid an operating condition in which many audio alert notifications are provided within a narrow time period. In one embodiment, the system enables the user to define a personal filtering profile, so that only messages relevant to the user are sent. In alternative embodiments, the filtering may be based on one or more properties of the object(s) or alert message(s), including, for example, the type of the object(s), the name of the object(s) (including name patterns), the location of the object(s), the inclusion of the object in a business process view, as is described in commonly owned U.S. patent application Ser. No. 09/545,024, filed Apr. 7, 2000, which is incorporated herein in its entirety by reference. The filtering may also be based on the severity of the alert, the time of day, the level of risk in a predicted event, the importance of the object and/or the importance, severity, type, name, etc. of object(s) impacted by the problem, which is described in commonly owned, concurrently filed related U.S. Utility Patent Application entitled “Method and Apparatus for Filtering Messages Based on Content”.

With continuing reference to FIG. 3, at block 315, a notification message is constructed based, in part, on the parameters of the detected alert condition and other factors or conditions known in the art. The notification message may be constructed based on other additional factors.

In one embodiment of the present application, to facilitate user understanding of the audio alert notifications, some of the terms and names commonly used in an enterprise management system operator's lexicon may be modified. For example, an identifier for an operating system that is publicly known as “NT Server” may be stored in a database as the single word “NTServer”, without any spaces separating the words. Such a single word identifier may be employed because many databases and programming languages do not permit spaces within an identifier. Further, users may use non-standard capitalization to aid in parsing non-standard words, and are adept at parsing such constructions even without the aid of capitalization. For example, “oraclev8” may be immediately recognized by an experienced user as referring to “Oracle Version 8”.

The command/control system may incorporate a facility for storing, in the object repository 110 or in one or more other databases, a pronounceable version of technical names that a speech generation system cannot identify a word or phrase. Alternatively, user readable and pronounceable names, with the embedded spaces, may be utilized as the public names of components, and the command/control system automatically generates the internal, technically acceptable name.

At block 320, the audio characteristics of the notification message are defined based on the detected alert condition. Audio characteristics may include, for example, volume, panning, distortion and resolution.

When an operator sitting in front of a computer receives an audio alert notification through the computer's speaker system, the next step is often to navigate through the standard on-screen user interface to bring the relevant object up on screen, to allow further inspection of the situation. In typical user interfaces, such navigation may involve counter-intuitive clicking and scrolling. In some modern user interfaces, such as 3-D “virtual reality” views, infinitely pan able 2-D maps and hyperbolic trees, the navigation is a seamless movement in some direction.

According to one embodiment of the present application, to assist the user to immediately navigate to an object, speech generation component 215 may use stereo or surround-sound speakers to position the source of the sound in the right direction. If the operator is looking at a part of a map, and an alert message is presented from the right, it is natural to scroll the screen to the right. Consequently, the use of audio characteristics may enhance the utility of the present application.

At block 325, the notification message is output via the notification path.

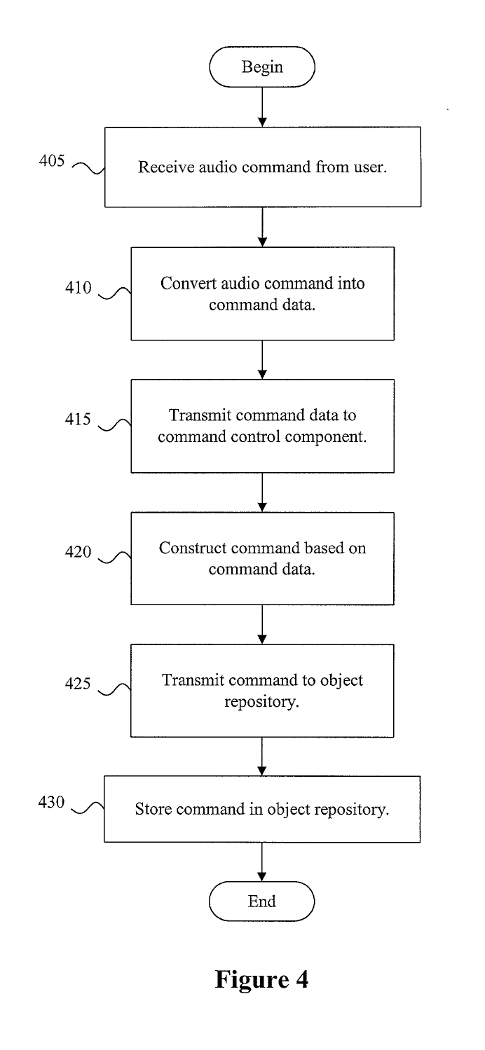

Referring now to FIGS. 2 and 4, the operation of one methodology for receiving an audio request/command will be described. At block 405, an audio request/command is received from a user. The audio request/command is received through router 220 by speech recognition component 210. The audio request/command is converted into command data (410) by speech recognition component 220. The resulting command data is then transmitted to command control component 250 for processing (415).

According to block 420, command control component 250 constructs a command based on the received command data. The command control component 250 transmits (425) the generated command to object repository 110 where it is stored (430) until retrieved and executed by the network management application 115.

While the present disclosure has been described with reference to a network management application, the disclosed methodology and systems may also be applied to business applications such as order processing or credit validation which may be interfaced with a management system and to its alert management systems. Thus, in an alternate embodiment, if a business application generates alert messages when inventory levels get below a certain threshold or credit card fraud is detected, for example, then those messages can be delivered to any human manager through computer speakers, a telephone or other audio-based device.

It should also be appreciated that disclosed interface is not limited to operating in a single human language. Although alert notifications generated by management systems or applications are typically generated in a specific language, most often in English because of the domination of the IT industry by American companies, there are many multinational enterprises that use such systems which employ human operators who may speak other languages. Therefore, according to alternate embodiments of the present system, the system may include a facility for translating the message to a language designated for a specific recipient, and then generating the audio alert notification.

Accordingly, it is to be understood that the drawings and description in this disclosure are proffered to facilitate comprehension of the system, and should not be construed to limit the scope thereof. It should be understood that various changes, substitutions and alterations can be made without departing from the spirit and scope of the system.

It should be noted that this application is related to concurrently filed U.S. Non-Provisional Applications entitled “Method And Apparatus For Generating Context-Descriptive Messages” and “Method And Apparatus For Filtering Messages Based On Context” both of which are incorporated herein by reference in their entirety. This application is further related to U.S. Pat. Nos. 5,958,012, 6,289,380 and 6,327,550, and co-pending U.S. application Ser. Nos., 09/558,897, and 09/559,237, which are all incorporated in their entirety herein by reference.

What is claimed is:

1. A method for generating an audio alert, comprising:
detecting an alert condition
determining a notification path associated with the alert condition;
constructing an audio notification message based on at least one parameter associated with the alert condition; and
outputting the audio notification message via the notification path.

2. The method of claim 1, further including defining audio characteristics associated with the audio notification message.

3. The method of claim 1, wherein constructing an audio notification message includes identifying a portion of the message that is likely to be difficult for a user to understand and replacing the identified portion with a more easily understood synonym.

4. The method of claim 1, wherein detecting an alert condition includes detecting an alert condition within a plurality of subsystems of a network management application.

5. The method of claim 1, further comprising defining at least one audio characteristic associated with the audio notification message.

6. The method of claim 5, wherein the audio characteristic is a volume.

7. The method of claim 5, wherein the audio characteristic is a balance.

8. The method of claim 1, wherein the audio messages presented in accordance with a filter.

9. The method of claim 1, wherein the determining the notification path includes analyzing a parameter associated with the alert condition and selecting the notification path based on the parameter.

10. The method of claim 1, wherein determining the notification path includes analyzing an escalation list.

11. The method of claim 1, wherein constructing the audio notification message includes:
determining a user associated with the audio notification message;
determining a language preference associated with the user; and
constructing the audio message based on the language preference.

12. A method for processing an audio command, comprising:
receiving an audio command from a user;
processing the audio command to derive command data;
constructing a command based on the command data; and
storing the command in an object repository.

13. A system for generating an audio alert, comprising:
means for detecting an alert condition
means for determining a notification path associated with the alert condition;
means for constructing an audio notification message based on at least one parameter associated with the alert condition; and
means for outputting the audio notification message via the notification path.

14. A system for processing an audio command, comprising:
means for receiving an audio command from a user;
means for processing the audio command to derive command data;
means for constructing a command based on the command data; and
means for storing the command in an object repository.

15. A computer-readable storage medium encoded with processing instructions for generating an audio alert, including:
computer readable instructions for detecting an alert condition
computer readable instructions for determining a notification path associated with the alert condition;
computer readable instructions for constructing an audio notification message based on at least one parameter associated with the alert condition; and
computer readable instructions for outputting the audio notification message via the notification path.

16. A computer-readable storage medium encoded with processing instructions for processing an audio command, including:
computer readable instructions for receiving an audio command from a user;
computer readable instructions for processing the audio command to derive command data;
computer readable instructions for constructing a command based on the command data; and
computer readable instructions for storing the command in an object repository.
